(19) United States
(12) Patent Application Publication
(10) Pub. No.: US 2010/0006637 A1
(43) Pub. Date: Jan. 14, 2010

(54) APPARATUS AND METHOD FOR DETECTING AT LEAST ONE OBJECT IN A PACKAGE

(76) Inventors: Uwe STROINSKI, Waiblingen (DE); Anton Mayer, Gilching (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/425,146

(22) Filed: Apr. 16, 2009

(30) Foreign Application Priority Data
Apr. 16, 2008 (DE) 10 2008 001 211.4

(51) Int. Cl. G06K 7/10; G06F 17/00

(52) U.S. Cl. 235/375; 235/454; 250/358.1

(57) ABSTRACT

A method and an apparatus are proposed for detecting at least one object in a package, in which at least one object is provided with an optical code and is disposed in a package. The method includes the steps of first irradiating the code through the package by electromagnetic excitation radiation. The code on being irradiated with the electromagnetic excitation radiation emits electromagnetic radiation, which is of higher or lower energy compared to the excitation radiation. Then the electromagnetic radiation is evaluated for whether the object is located in the package.

### CROSS-REFERENCE TO RELATED APPLICATION

This application is based on German Patent Application 10 2008 001 211.4 filed Apr. 16, 2008.

### BACKGROUND OF THE INVENTION

1. Field of the Invention

The present invention relates to an optical code, a method for producing the code, an information carrier which has an optical code, and a method for automated readout of the code in already-closed package bundles.

2. Description of the Prior Art

From European Patent Disclosure EP 1 736 914 A, an optical code and a method for its production are already known. An optical code, upon irradiation with electromagnetic excitation radiation from the infrared spectrum, emits electromagnetic radiation, which is of lower energy compared to the excitation radiation. The optical code can be applied or introduced onto or into any kind of ink, and conventional printing methods may be employed. Certain material characteristics of the optical code may be used as proof, including of originality, of the information carrier that is provided with the optical code.

The end user, whether it is a private or an industrial customer, is accustomed to receive his products not in open or bulk form but instead in packaged form. Various forms and types of packaging are known. A common feature of them all is that they can be used both as a shipping bundle and for protecting the product. The surface of the package is also used as an information carrier and for design purposes. This is especially, but not exclusively, true for cardboard packages.

Various packaging components are put together to make packaging and shipping bundles. More and more often, these bundles contain combinations of individual products, whether they are combined preparations in the pharmaceutical field, where different active ingredients reach the patient separately, or for instance multicomponent glues that cannot be allowed to come together until when they are actually used. Especially in the pharmaceutical field, but not exclusively in that field, package inserts on the medications or products are necessarily added as well. If products are missing from the package bundle, then in the first place this is annoying to the purchaser. If one component is missing from a combination product, then the product is no longer functional or—in pharmaceutical terms—is not effective. If a package insert is missing from a medication package, this is a grave mistake, and the affected batch of packages has to be recalled. Checks of the package contents are already performed at present, but they do not offer any certainty that after the package is closed, all the parts are actually inside the package. Attempts to weigh a closed package unit, for instance, rapidly run up against the limits of what is technically feasible. For instance, the weight of package inserts is sometimes negligibly slight in comparison to the weight of the total package. Gravimetric weighing fails to detect lighter-weight contents or objects in proportion to heavy objects (an example: a pharmaceutical product, such as a 500 ml glass bottle with patient information on a package insert).

Other methods, such as ultrasound or scanning with X-radiation or other penetrating types of radiation are highly dependent on the packaging material, the disposition of the objects to be detected, and naturally the object itself.

### OBJECT AND SUMMARY OF THE INVENTION

It is therefore the object of the invention to make available an optical code of products, a method for producing the code on or in products, an information carrier which has an optical code, and a method for automatic readout of the code in already-closed packaging, in which the problems in the prior art are at least partially overcome.

This object is attained by the optical code, the method for producing an optical code, the information carrier including an optical code, and the method for readout of an optical code, even in already-closed package bundles, according to the advantageous features and refinements of the invention.

In one aspect of the present invention, an optical code is made available which upon irradiation with beams from a first energy spectrum emits beams from a second energy spectrum, and the second energy spectrum includes beams of lower energy. In further aspects of the present invention, a method for producing such an optical code is presented, and an information carrier including such an optical code and the method for readout of an optical code, even in already-closed package bundles, are made available.

The optical code according to the invention has the advantage that if desired it is not recognizable as a code in daylight. Moreover, dirt on the codes does not affect their legibility to the same extent as with codes that are excited by radiation in the optically visible range. This is due to the fact that the excitation radiation is in the infrared spectrum and is absorbed to a lesser extent by dirt or used cardboard boxes than is radiation in the visible optical spectrum. If, as is proposed in a preferred embodiment, the excitation radiation and the emitted radiation are both in the infrared spectrum, then a comparatively only minimal proportion of the radiation is absorbed by layers of dirt, for instance, or layers of paper located over the code. The evaluation is thus facilitated.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 shows a fragment of a packaging machine that comprises a plurality of components;

FIG. 2 shows a detail of the detection device in FIG. 1;

FIG. 3 shows the detection device upon detection of an enclosure by means of LNP printing and an IR source/detector;

FIG. 4 shows the detection device upon detection of a product through the package and through a package insert;

FIG. 5 shows the detection device upon detection of a product and an enclosure by evaluation of radiations emitted by them both; and

FIG. 6 shows the course over time of the radiation output.

### DESCRIPTION OF THE PREFERRED EMBODIMENTS

A packaging machine 4 comprises a conveyor device 6, such as a conveyor belt, which conveys a package 10 into the range of action of an insertion device 8. The insertion device fills the opened package 10 with a product 12, such as the product to be packaged or other enclosures 16 such as a package insert (FIGS. 3-5), product descriptions, or the like. The conveyor device 6 conveys the filled package 10 to a closing device 9. The closing device 9 acts for instance transversely to the conveying direction on the still-open side parts of the package 10 and folds them over in the direction of closure. Next, the now-closed package 10 reaches the range of action of a detection device 26, the mode of operation of which will be addressed later herein. Next, the package 10, with the product 12 and the optional enclosure 16, reaches an ejector 11. The ejector 11 removes packages 10 that were not properly filled and have been identified as defective. The identification of a defectively filled package 10 can be made for instance with the aid of the detection device 26.

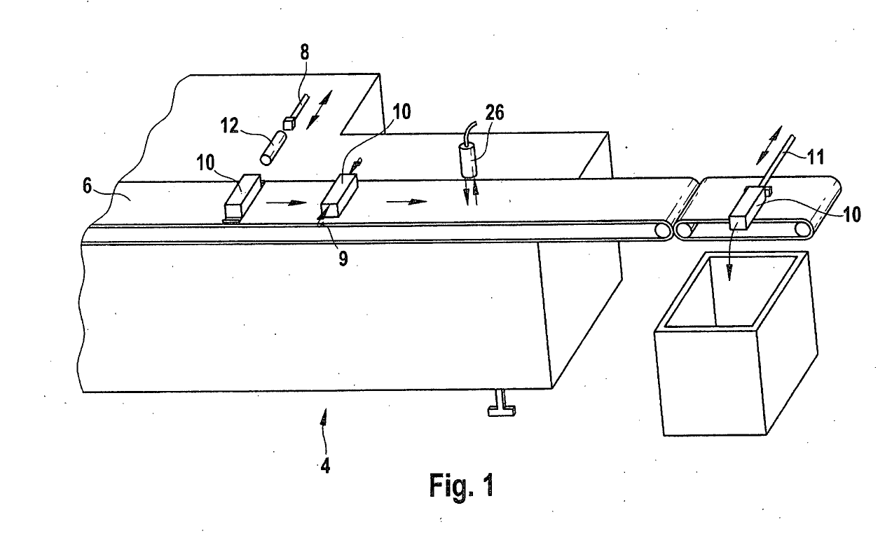

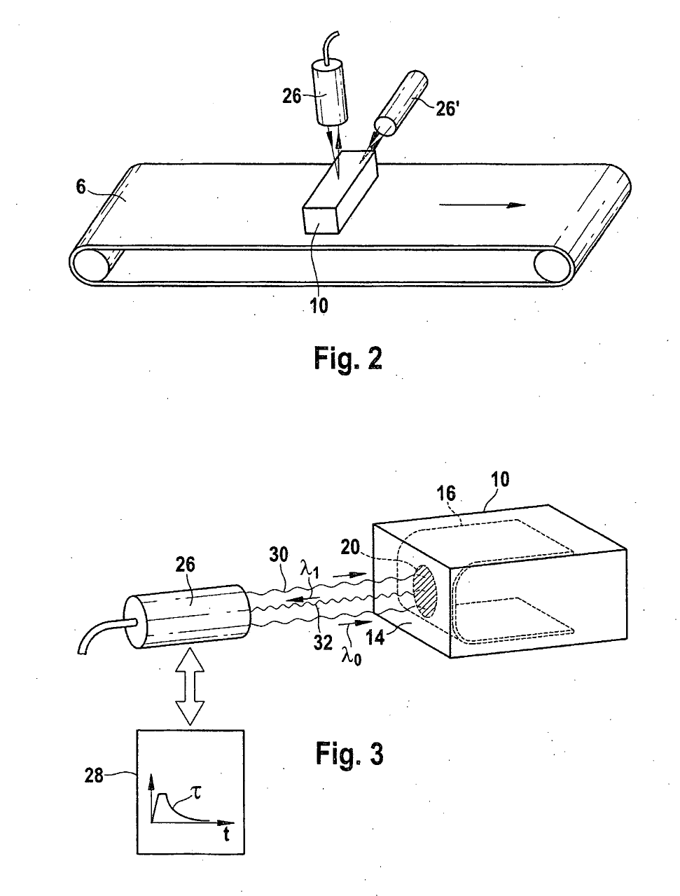

In FIGS. 2-5, the detection device 26 of FIG. 1 is shown in greater detail. A transceiver 26 is disposed above the conveyor device 6 and emits and receives the radiation perpendicular to the plane of the conveyor device 6. Alternatively, the transceiver 26′ could also emit and/or receive radiation parallel to the plane of the conveyor device 6. In each case, the transceiver 26 is disposed such that the emitted excitation radiation 32 passes through the side wall of the package 10, located on the conveyor device 6, into the interior of the package 10.

In FIGS. 3 through 5, differently filled packages 10 are shown. In the example in FIG. 3, an enclosure 16, such as a package insert, is to be detected. To that end, the enclosure 16 is imprinted with luminescent nanoparticles 20.

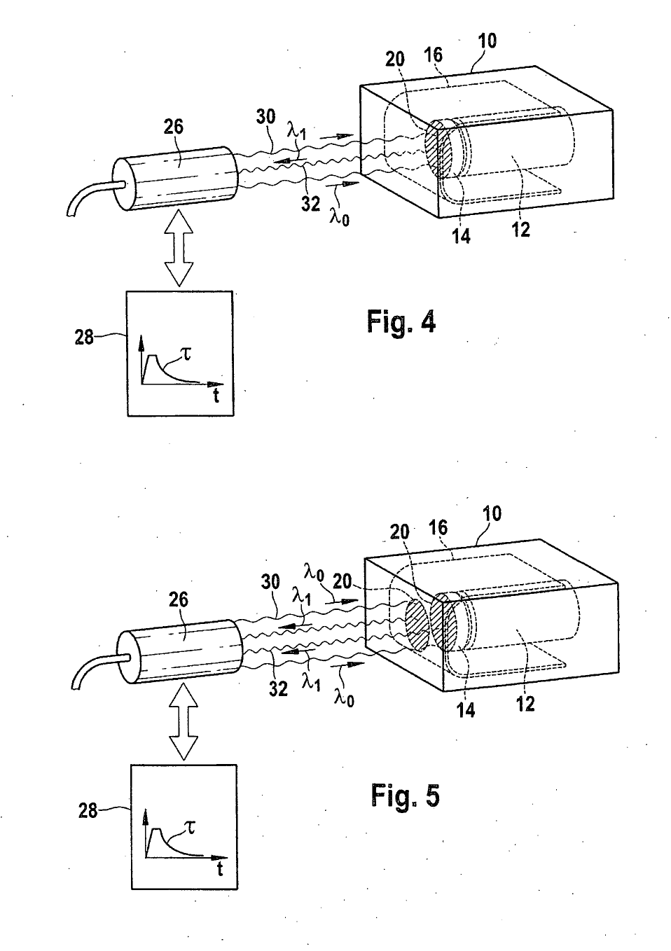

In the exemplary embodiment of FIG. 4, a product 12 that might be located in the package 10 is to be detected through the package 10 and an enclosure 16. The product 12 is for instance a container, such as a bottle, vial, or the like. The product 12 is closed on one side by a closure 14. The product 12 may include dispensed product, which is not shown separately. The closure 14 includes luminescent nanoparticles (LNPs), which for, an optical code 20. These luminescent nanoparticles may for instance be added to a granulate from which the closure 14 is produced in the form of an injection-molded part, or supplied by a paint mixed with LNPs. Inside the package 10, an enclosure 16, such as a package insert, is also located around the closure side of the product 12 but is not provided with luminescent nanoparticles.

The exemplary embodiment in FIG. 5 differs from that of FIG. 4 in that in addition, the enclosure 16 as well is provided with a code 20 of luminescent nanoparticles Thus both the product 12 and the enclosure 16 can be detected by the presence of the codes 20.

For all the exemplary embodiments in FIGS. 3 through 5, a transceiver 26 is located outside the closed package 10 and transmits electromagnetic excitation radiation 30 into the interior of the package 10. This excitation radiation 30 excites the luminescent nanoparticles of either the code of the enclosure 16 or the closure 14, depending on the exemplary embodiment, so that they emit an electromagnetic radiation 32. This emitted radiation 32 is detected by the transceiver 26 and evaluated by means of a control and evaluation unit 28. The emitted radiation 32 furthermore provides information as to whether the closed package 10 has been properly filled with objects—which depending on the exemplary embodiment are the product 12 and optionally the closure 14 and enclosure 16.

A code 20 in the form of the luminescent particles is made available which upon radiation with excitation beams 30 from a first energy spectrum emits radiation 32 from a second energy spectrum includes radiation 32 of higher energy, preferably up to approximately 800 nm, or lower energy than the first energy spectrum.

This type of code 20 has the advantage that in daylight, if this is desired, it is not recognizable as a code. Moreover, dirt on the codes 20 do not affect their legibility to the same extent as with codes that are excited by excitation radiation 30 in the optically visible range. This is due to the fact that the excitation radiation 30 is preferably in the infrared spectrum and is not absorbed as much by dirt or by used cardboard boxes than is excitation radiation 30 in the visible optical spectrum. If both the excitation radiation 30 and the emitted radiation 32 are in the infrared spectrum, then a comparatively only minimal proportion of the radiation, for instance of layers of dirt or paper located over the code 20, is absorbed. This facilitates the evaluation. The excitation radiation 30 is preferably used from the infrared spectrum, in particular with a wavelength of approximately 750 nm to 1000 nm or 1.5 μn to 1.8 μm, in particular approximately 1540 nm and 1750 nm.

The materials used for the code 20 and for the automatic readout of the code 20 in already-closed packages 10 or package bundles are preferably selected from the group of rare earth ceramics. However, other ceramic materials that display the desired effect may also be used. For instance, ZNS, Ag, and Cu compounds also display the desired effects. An optical property that in physics is called “Stokes' Law” is known. These materials absorb light from a defined spectral range and emitted radiation 32 of a longer wavelength. The rare earth compounds preferably employed use excitation radiation 30 from the near-infrared range, preferably between 750 nm and 1000 nm, in order to emit infrared radiation 32 in the range from 800 nm to 1600 nm—preferably from 1000 nm to 1200 nm and from 1500 nm to 1800 nm. This emitted light is material-characteristic in its wavelength and in its signal behavior over time.

With this code 20, by utilizing the material-characteristic properties of the luminescent nanoparticles used, optically coded objects 12, 14, 16 can be located even in a closed package 10 or a closed package bundle. To that end, the so-called penetration depth of infrared radiation into or through materials—for instance, but not exclusively, paper cardboard boxes—is employed.

The term “objects 12, 14, 16” or “information carriers”, in the context of the present invention, encompasses all articles onto or into which a code 20 can be attached or introduced. This is either the object itself, such as a medication bottle 12 or for instance sheets of paper or plastic 16, such as package inserts or labels. The codes 20 may be applied directly to the objects 12, 14, 16 to be marked, as long as the surface thereof permits sufficient adhesion of the code 20. It is also possible to introduce the optical code 20 directly into the object 14, for instance in plastic, synthetic resins, paper, wax, or glass.

It is furthermore possible for the code 20 to be introduced into or onto metals, such as aluminum or magnesium. Typically, the optical code 20 is machine-readable. The optical code 20 is preferably encoded with the aid of known encoding systems, or is a proprietary code developed especially for the use of the code 20, that utilizes the special material properties of the luminescent nanoparticles and evaluates them in a sensor system. The term “optical spectrum” furthermore includes both the infrared and the optically visible spectrum.

The materials used, especially the luminescent nanoparticles, are also used for identification purposes; based on material-characteristic functions upon their excitation and/or upon phosphorescence, that is, immediately after the shutoff of the excitation radiation 30, specific individual-object information can be read out. Such information may for instance be information on the material composition, on the manufacturer, on product batches, etc.

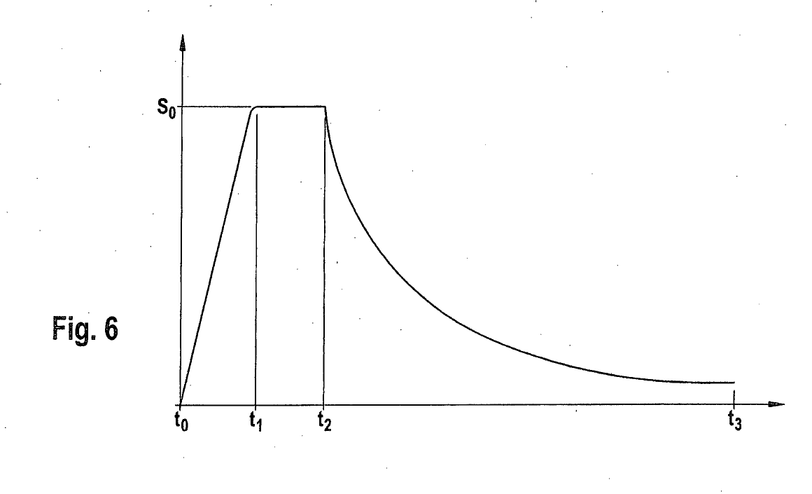

Preferably, the things that are evaluated are the luminescence, that is, the time of phosphorescence after the exciting radiation 30 is switched off, the signal intensity S of the luminescence at a certain time after the shutoff of the exciting radiation 30, and a variable for the nonlinearity of the luminescence (calculated from the difference between a linear drop in a function and the drop in an e-function). Mathematically, the phosphorescence can be expressed in the form of a fading curve as an e-function (exponential function on base e) with a material-characteristic value Tau (τ) in the exponent. One example of a course over time of the radiation output is shown in FIG. 6.

In an exemplary embodiment, the fading time constant Tau is ascertained and evaluated, in that the phosphorescence time is divided into n measurement points at which the signal intensity is measured. The succession of these measurements over time may vary, in order to take into account the variously long-lasting luminescence for different codes 20.

The signal intensity S₀ at the onset of the phosphorescence is dependent on the material and on the concentration of the material. For instance, the signal intensity virtually doubles as in FIG. 5, if the closed package 10 contains two optical codes 20, instead of only one code 20 as shown for example in FIGS. 3 and 4.

In some situations, it is desirable to use a special customer mixture for the code 20. Since the codes 20 can vary sharply in their Tau values, the mixtures then exhibit a specific but each different Tau. The e-functions are superimposed on one another and result in a new Tau, which is obtained replicably for the applicable mixture.

In other situations, a purely yes/no detection can be performed, depending on whether a code 20 is present or not. In that case, it suffices to determine the deviation of the luminescence curve from linear fading. The radiation of the luminescence curve is compared in simplified form in a period T₁ at the onset with the slope of the curve at the end of the luminescence T₂. These two values are compared with one another. For ascertaining this parameter, even very slight signal intensities suffice; that is, at even slight concentrations or relatively long measurement intervals, reliable yes/no statements are obtained. Reliable yes/no detections are attainable down to concentrations of less than 0.01 g/m² LNP, preferably 0.01 g/m² LNP or less for surface markings or below 0.01% in the case of mixtures, preferably 0.01% or less for admixture in solid bodies, such as plastics.”

It is appropriate that for reading out this information, transceivers 26 are used whose resolution over time is less than 0.1 ms, especially 500 to 2 μs and below. Typical times between the switching on of the excitation until an emission plateau is reached amount to from 0.1 to 1 ms and depend as a rule on both the type of material of the code 20 and the temperature. The term “emission plateau” is understood to mean a saturation power emission value S₀, which indicates how much power is emitted by the optical code 20 at a constant excitation. Typical phosphorescence periods between the time T₂ when the excitation is switched off until the emission fades amount to between 0.1 ms and several hundred ms, particularly from 0.1 to 50 ms and from 0.1 to 3 ms, and as a rule depend on both the type of material and the temperature. The term fading of the emission is understood to mean that less than 35%, and typically 5%, of the originally maximum emission output is emitted by the code 20. Material properties that are variable in this way may be partial or complete carriers of the encoded information. In other words, the optical code 20 may comprise the fact that different objects 12, 14, 16 with different compositions of the selected materials are measured together as encoding information carriers and in the process, based on the different material characteristics, such as excitation and phosphorescence properties, they furnish specific information. This information can in turn be read out and evaluated as an optical code. For instance, as a result, the presence of one, two, or more package inserts 16 or other enclosures 16 in a package bundle 10 can be proven using only a single measurement, if the optical codes 20 of each package insert 16 deviate from one another, for instance by the amount 10 for the parameter Tau. For instance, a first package insert 16A has a first optical code 20A with LNP with a Tau of 400 nm. The second package insert 16B has a Tau of 1100 nm. The evaluation unit 28 measures a Tau of 400 nm when the package insert 16A is present. The evaluation unit 28 measures a Tau of 1100 nm if only package insert 16B is present and a Tau of approximately 750 nm if both package inserts 16A, 16B are found simultaneously.

In a further variant of the optical code 20, Tau is kept constant for each object, such as a package insert 16. If the package insert 16 is present, the transceiver 26 receives a signal that is proportional to the radiation 32. If no package insert 16 is present, it receives no signal. If there are two package inserts 16, a signal is received which is substantially stronger than when there is only one package insert 16. By this means, the second package insert 16 can be detected.

In a further version, the received, preferably infrared radiation 32 is detected with regard to its wavelength. This is preferably done using a fiber optical waveguide. It has one or more fiber optic cables for receiving the preferably infrared radiation 32. By means of an optical splitter, one portion of the emitted radiation 32 is used for instance for determining Tau, while the other portion is carried to a spectral analyzer. It analyzes the emitted light both in the visible range, preferably from 250 nm to 750 nm, and in the infrared range, preferably from 750 nm to 1800 nm. This measuring method enables high resolution of optically encoded objects 12, 14, 16 located side by side in a package bundle, even in the case of very small codes 20 of less than 1 mm in diameter.

Current printing methods may be used for printing the code 20, such as laser printing, rotogravure printing, flexographic printing, offset printing, screen printing, thermal transfer printing, or inkjet printing. The printing ink includes a carrier substance, for instance but not exclusively transparent white, and the luminescent material, which upon excitation emits electromagnetic radiation 30. The particle size of the luminescent material is preferably between 0.005 μm and 100 μm, and particle sizes in the range from 0.05 μm to 0.1 μm, from 1 μm to 5 μm, or from 10 μm to 100 μm are especially preferred.

A method for detecting at least one object 12, 14, 16 in a package 10 includes at the following steps:
the code 20 is applied to at least one object 12, 14, 16;
the object 12, 14, 16 is placed in a package 10;
the code 20 is irradiated through the package 10 with electromagnetic excitation radiation 30;
upon being irradiated with the electromagnetic excitation radiation 30, the code 20 emits electromagnetic radiation 32, which is of higher or lower energy compared to the excitation radiation;
and the electromagnetic radiation 32 is evaluated for whether the object 12, 14, 16 is located in the package 10.

The electromagnetic radiation 32 is evaluated with regard to the material-specific parameters of the code 20. In particular, for instance, the course over time, the fading behavior (Tau) over time, or the signal intensity of the electromagnetic radiation 32 is evaluated. At least one characteristic parameter (Tau, S₀) of the electromagnetic radiation 32 is compared with a limit value for detecting whether the object 12, 14, 16 is located in the package 10. In a refinement, the electromagnetic radiation 32 can be evaluated, for detecting whether a plurality of objects 12, 14, 16, each provided with a code 20, is located in the package 10. To that end, these objects 12, 14, 16 are each provided with codes 20 that differ in their characteristic behavior. Preferably, the codes 20 differ with regard to their fading behavior (Tau) over time and the signal intensity S₀.

This apparatus is preferably located inside a cardboard-box-making machine, but it may also be used peripherally as a separate testing module.

With the aid of an apparatus and making use of the described physical effect, objects 12, 14, 16 inside an already-closed package 10 are to be proven as to their existence and, if needed, can also be distinguished from one another.

The product 12, 14, 16 to be detected must be put into contact beforehand with a code 20, for instance comprising luminescent nanoparticles. This can be done by painting with a clear lacquer enriched with luminescent nanoparticles, or in inkjet ink mixed with luminescent nanoparticles. In the case of plastic parts, these luminescent nanoparticles can already be contained in the injection-molding granulate, for instance in a production of a closure 14 for closing the product 12.

These luminescent nanoparticles emit infrared electromagnetic radiation 32 when they in turn are excited with electromagnetic excitation radiation 30 from the infrared spectrum. The frequency of the emitted radiation 32 is dependent on the properties of the particular luminescent nanoparticles and on the frequency of the radiation 30 used for the excitation. In the system for detecting objects 12, 14, 16 in already-closed packages 10, the excitation frequencies and the luminescent nanoparticles are adapted to one another.

The excitation radiation 30 penetrates the package 10 and excites the object 12, 14, 16 that is located inside the package and is encoded with luminescent nanoparticles. The emitted radiation 32 in turn penetrates the package 10. As the transmitter 26, an infrared radiation source in which the emitted electromagnetic radiation 30 is adjustable is for instance employed. Preferably, infrared radiation of between 7500 and 1000 nm is used. The emitted radiation 30 is in turn detected by one or more infrared detectors, as an example for a receiver 26.

If more than one object 12, 14, 16 is to be detected, then different luminescent nanoparticles, different infrared frequencies, or surfaces spatially variously supplied with luminescent nanoparticles can be used.

In a cardboard-box-making machine, vials 12, for instance, with pharmaceutical active ingredients are packaged. The vial 12 is closed by the plastic stopper 14. The stopper 14 was made from an injection-molding granulate that was enriched with luminescent nanoparticles. This vial 12 is now surrounded in C-shaped fashion by a package insert 16 in the cardboard package 10.

The infrared transmitter 26 emits excitation radiation 30 in the infrared range at a defined wavelength, which penetrates the cardboard package 10. Upon striking the surface, imprinted with defined luminescent nanoparticles, of the package insert 16, these particles are excited as described by the excitation radiation 30. The radiation 32 thereupon emitted, however, passes through the package 10 and strikes the infrared receiver 26. This radiation 32 is converted into electrical variables. The control and evaluation unit 28 compares the incoming values with the set-point values stored in memory. By utilizing the signal intensity and the variable Tau of the fading function, the presence of the package insert 16 can be unambiguously proven.

If a second object, a package insert 16, or as in the example a vial 12, is supplied with by further luminescent nanoparticles, then given a suitable choice of the material-specific parameters, but not exclusively Tau (τ), a conclusion as to the presence of the objects 12, 14, 16 in the closed package 10 can be drawn with only a single measurement.

The foregoing relates to a preferred exemplary embodiment of the invention, it being understood that other variants and embodiments thereof are possible within the spirit and scope of the invention, the latter being defined by the appended claims.

We claim:

1. A method for detecting at least one object in a package, in which at least one object is provided with a code and is disposed in a package, including the following steps:
irradiating the code through the package by electromagnetic excitation radiation;
emitting electromagnetic radiation from the code upon being irradiated with the electromagnetic excitation radiation, which emitted radiation is of higher or lower energy compared to the excitation radiation; and
evaluating the emitted radiation for detecting whether the object is located in the package.

2. The method as defined by claim 1, wherein a course over time and/or a signal intensity and/or a wavelength of the emitted radiation is evaluated for detecting whether the object is located in the package.

3. The method as defined by claim 1, wherein the fading behavior over time of the emitted radiation is evaluated.

4. The method as defined by claim 2, wherein the fading behavior over time of the emitted radiation is evaluated.

5. The method as defined by claim 1, wherein at least one characteristic parameter of the emitted radiation is compared with a limit value for detecting whether the is located in the package.

6. The method as defined by claim 4, wherein at least one characteristic parameter of the emitted radiation is compared with a limit value for detecting whether the is located in the package.

7. The method as defined by claim 1, wherein the emitted radiation is evaluated for detecting whether a plurality of objects each provided with a code are located in the package.

8. The method as defined by claim 6, wherein the emitted radiation is evaluated for detecting whether a plurality of objects each provided with a code are located in the package.

9. The method as defined by claim 1, wherein a plurality of objects are each provided with different codes, which differ by at least one characteristic parameter for instance with regard to fading behavior over time.

10. The method as defined by claim 8, wherein a plurality of objects are each provided with different codes, which differ by at least one characteristic parameter for instance with regard to fading behavior over time.

11. The method as defined by claim 1, wherein as the excitation radiation, infrared radiation, preferably with a wavelength of approximately 750 nm to 1000 nm is used.

12. The method as defined by claim 10, wherein as the excitation radiation, infrared radiation, preferably with a wavelength of approximately 750 nm to 1000 nm is used.

13. The method as defined by claim 1, including at least one of the following further steps:
applying the code to at least one object; and/or
introducing the object into the package; and/or
closing the package; and/or
transporting the package to a transceiver, which transmits the excitation radiation and/or receives the emitted radiation.

14. The method as defined by claim 12, including at least one of the following further steps:
applying the code to at least one object; and/or
introducing the object into the package; and/or
closing the package; and/or
transporting the package to a transceiver, which transmits the excitation radiation and/or receives the emitted radiation.

15. The method as defined by claim 1, including the step of rejecting the package depending on the evaluating the emitted radiation for detecting whether the object is located in the package.

16. The method as defined by claim 14, including the step of rejecting the package depending on the evaluating the emitted radiation for detecting whether the object is located in the package.

17. An apparatus for detecting at least one object in a package, comprising:
at least one transmitter, which transmits an electromagnetic excitation radiation through a package in which at least one object provided with a code is disposed;
at least one transceiver, which detects an emitted electromagnetic radiation upon irradiation of the code with the electromagnetic excitation radiation, the emitted electromagnetic radiation being of higher or lower energy compared to the excitation radiation; and
at least one evaluation unit, which evaluates the emitted radiation to detecting whether the object is located in the package.

18. The apparatus as defined by claim 17, wherein the code is embodied as luminescent nanoparticles.

19. The apparatus as defined by claim 17, further comprising:
at least one device for applying the code to at least one object; and/or
at least one insertion device for inserting the object into the package; and/or
at least one closing device for closing the package; and/or
at least one conveyor device for transporting the package to the transceiver; and/or
at least one ejector for rejecting a defectively filled package, for which the evaluation unit has detected a missing object in the package.

20. The apparatus as defined by claim 18, further comprising:
at least one device for applying the code to at least one object; and/or
at least one insertion device for inserting the object into the package; and/or
at least one closing device for closing the package; and/or
at least one conveyor device for transporting the package to the transceiver; and/or
at least one ejector for rejecting a defectively filled package, for which the evaluation unit has detected a missing object in the package.
